(19) United States
(12) Patent Application Publication
(10) Pub. No.: US 2026/0200317 A1
(43) Pub. Date: Jul. 16, 2026

(54) KNOB, VEHICLE, AND METHOD FOR CONTROLLING VEHICLE

(71) Applicants: Hyundai Motor Company, Seoul (KR); Kia Corporation, Seoul (KR)

(72) Inventor: Zhe LI, Yantai (CN)

(21) Appl. No.: 19/446,255

(22) Filed: Jan. 12, 2026

(30) Foreign Application Priority Data
Jan. 13, 2025 (CN) 202510051988.2

(51) Int. Cl. B60K 35/10

(52) U.S. Cl. CPC B60K 35/10; B60K 2360/111; B60K 2360/126; B60K 2360/128; B60K 2360/145; B60K 2360/47; B60K 2360/5915

(57) ABSTRACT

The present disclosure relates to a control knob, a vehicle and a method for controlling the vehicle. The control knob may include a bottom portion, a top portion, and a controller circuit. The bottom portion may include: a contact panel and a magnet. The top portion may be configured to: connect to and rotate with respect to the bottom portion, and be pressed with respect to the bottom portion. The top portion may include a touch display panel. The controller circuit may be configured to: switch, based on receiving a control knob mode switching signal from the vehicle, an operation mode of the control knob; display, on the touch display panel, a user interface corresponding to control function information received from the vehicle; and transmit, based on a user input received by the top portion, an operation signal for a control function corresponding to the user input.

### CROSS-REFERENCE TO RELATED APPLICATION

This application claims priority to and the benefit of Chinese Patent Application No. 202510051988.2 filed at the China National Intellectual Property Administration on January 13, 2025, the entire contents of which are incorporated herein by reference.

### TECHNICAL FIELD

The present disclosure relates to vehicle control technology, and more particularly to user interfaces in a vehicle.

### BACKGROUND

Vehicles may be equipped with audio, video, and navigation (AVN) systems or entertainment information systems. The size and number of displays are gradually increasing, allowing more information to be displayed simultaneously.

As touchscreens are more widely adopted as vehicle displays, the use of software (e.g., non-physical) buttons is increasing, and the use of hardware (e.g., physical) buttons in vehicles is decreasing. To adapt to large screen displays, more and more car manufacturers have removed hardware buttons, relying primarily on software buttons to control vehicle functions. On the other hand, the large size of the display may cause inconvenience to drivers as they cannot easily operate the AVN system through the software buttons from their seats.

The above information disclosed in this Background section is provided only to facilitate understanding of the background of the present disclosure, and may therefore include information that is not a part of the prior art that would be already known to those skilled in the art to which the present disclosure pertains.

### SUMMARY

One or more example embodiments of the present disclosure provide a knob, a vehicle, and a method for controlling a vehicle, which allows a user to easily operate software buttons from a seat by positioning the knob in a convenient position on a vehicle display.

According to one or more example embodiments of the present disclosure, a control knob of a vehicle may include: a bottom portion, a top portion, and a controller circuit. The bottom portion may include: a contact panel provided on a bottom surface of the bottom portion, and a magnet installed on an inner surface of the contact panel. The magnet may be configured to attach, by magnetic force, to a magnetic material installed inside a display of the vehicle. The top portion may be configured to: connect to the bottom portion, rotate with respect to the bottom portion, and be pressed with respect to the bottom portion. The top portion may include a touch display panel provided on an upper surface of the top portion. The controller circuit may be configured to: switch, based on receiving a control knob mode switching signal from the vehicle, an operation mode of the control knob to one of: a multi-function mode, a remote-control mode, or a smart key mode; display, on the touch display panel and based on the control knob being switched to the multi-function mode, a user interface corresponding to control function information received from the vehicle; and transmit, to the vehicle and based on a user input received by the top portion, an operation signal for a control function corresponding to the user input. The user input may include at least one of: a rotation of the top portion, a press of the top portion, or a touch input on the touch display panel.

The control function information may include a control function type. The control function type may include at least one of: a seat control function, a multimedia playback control function, or an air conditioning control function.

The control knob may further include a wireless communication interface. The controller circuit may be further configured to: receive, from the vehicle via the wireless communication interface, the control knob mode switching signal and the control function information. The controller circuit may be configured to transmit the operation signal by: transmitting the operation signal to the vehicle via the wireless communication interface.

The wireless communication interface may include: an ultra-wideband antenna, and an ultra-wideband transceiver electrically connected to the ultra-wideband antenna.

The bottom portion may further include a wireless charging coil installed on the inner surface of the contact panel.

According to one or more example embodiments of the present disclosure, a vehicle may include a display device. The display device may include a magnetic material portion. The magnetic material portion may be configured to attach, by magnetic force, to a magnet installed in a removable control knob. The vehicle may further include a controller circuit configured to: transmit, to the removable control knob and based on a user input signal indicating an operation mode of the removable control knob, a corresponding control knob mode switching signal; based on the operation mode of the removable control knob being a multi-function mode and based on receiving the user input signal regarding a control function, transmit, to the removable control knob that is attached to the display device, control function information corresponding to the user input signal; and control, based on an operation signal for the control function received from the removable control knob that is attached to the display device, the control function.

The controller circuit may be configured to transmit the control function information by: detecting whether the removable control knob is attached to the display device when the user input signal is received; and, based on detecting that the removable control knob is attached to the display device when the user input signal is received, transmitting the control function information that corresponds to the user input signal.

The control circuit may be further configured to: detect whether the removable control knob is attached to the display device when a second user input signal is received; and, based on detecting that the removable control knob is not attached to the display device when the second user input signal is received, not respond to the second user input signal.

The controller circuit may be further configured to: detect a position, relative to the display device, of the removable control knob attached to the display device; and adjust, based on the detected position of the removable control knob attached to the display device, a layout of a user interface of the display device so that the removable control knob does not obscure information on the user interface.

The control function information may include a control function type. The control function type may include at least one of: a seat control function, a multimedia playback control function, or an air conditioning control function.

According to one or more example embodiments of the present disclosure, a method performed by an apparatus for a vehicle may include: receiving a user input requesting to switch an operation mode of a removable control knob of the vehicle to a multi-function mode; switching, based on the receiving of the user input requesting to switch to the multi-function mode, the operation mode of the removable control knob to the multi-function mode by transmitting, to the removable control knob, a control knob mode switching signal for the multi-function mode; receiving a user input signal regarding a control function; based on receiving the user input signal, transmitting, to the removable control knob that is attached to a display device of the vehicle, control function information to cause the removable control knob to display, on a touch display panel of the removable control knob, a control knob user interface corresponding to the control function information; receiving, from the removable control knob, an operation signal, for the control function, corresponding to a user operation of the removable control knob; and controlling, based on the operation signal, the control function.

The method may further include: receiving a second user input requesting to switch the operation mode of the removable control knob to a remote-control mode; and transmitting, to the removable control knob and based on the receiving of the second user input, a second control knob mode switching signal for the remote-control mode.

The method may further include: receiving a second user input requesting to switch the operation mode of the removable control knob to a smart key mode; and transmitting, to the removable control knob and based on the receiving of the second user input, a second control knob mode switching signal for the smart key mode.

Transmitting the control function information may include: detecting whether the removable control knob is attached to the display device when the user input signal is received; and, based on detecting the removable control knob is attached to the display device when the user input signal is received, transmitting the control function information that corresponds to the user input signal.

The method may further include: detecting whether the removable control knob is attached to the display device when a second user input signal is received; and, based on detecting that the removable control knob is not attached to the display device when the second user input signal is received, not responding to the second user input signal.

The method may further include: detecting a position, relative to the display device, of the removable control knob attached to the display device; and adjusting, based on the detected position of the removable control knob attached to the display device, a layout of a vehicle user interface of the display device so that the removable control knob does not obscure information on the vehicle user interface.

The removable control knob may include an bottom portion. A contact panel may be provided on a bottom surface of the bottom portion. A magnet may be installed on an inner surface of the contact panel. A magnetic material portion may be installed inside the display device of the vehicle. The magnet may be attached to the magnetic material portion by magnetic force so that the removable control knob is attachable to the display device of the vehicle.

The removable control knob may include a top portion and a bottom portion. The top portion may be configured to: connect to the bottom portion; rotate with respect to the bottom portion; and be pressed with respect to the bottom portion. The top portion may include the touch display panel being provided on an upper surface of the top portion. The user operation may include at least one of: a rotation of the top portion, a press of the top portion, or a touch input on the touch display panel.

The method may further include: detecting a position of the removable control knob via ultra-wideband communication with the removable control knob to determine whether the removable control knob is attached to the display device and determine an attachment position of the removable control knob relative to the display device.

The control function information may include a control function type. The control function type may include at least one of: a seat control function, a multimedia playback control function, or an air conditioning control function.

According to embodiments of the present disclosure, in multi-function knob mode, the user may place the knob in a conveniently operable position on the vehicle display, so that the user may easily operate the software button from the seat.

Additionally, in remote-control mode, the user may remotely control the functions of the AVN system or the entertainment information system from a relatively comfortable position in the seat, and in smart key mode, the user may use the knob to execute smart key functions such as unlocking or locking the door.

In addition, any advantages that may be acquired or inferred from the example embodiment(s) of the present disclosure are directly or implicitly disclosed in the detailed description of the example embodiment(s) of the present disclosure. That is, various advantages inferred from the example embodiment(s) of the present disclosure are disclosed in the detailed description that follows.

### BRIEF DESCRIPTION OF THE DRAWINGS

Hereinafter, one or more example embodiments of the present disclosure are described in more detail with reference to the accompanying drawings. For clarity of description, identical parts in different drawings are indicated using the same reference numerals. It should be noted that the drawings are illustrative only and are not necessarily drawn to scale.

FIG. 1 is a schematic diagram illustrating an example system for controlling a vehicle.

FIG. 2 is a schematic diagram illustrating an example knob.

FIG. 3 is an exploded view of an example knob.

FIG. 4 is a schematic diagram illustrating a rear surface of an example display panel of a display device.

FIG. 5 is a schematic diagram illustrating an example map displayed on the display device.

FIG. 6 is a schematic diagram illustrating an example user interface (UI) window provided to allow a user to select a function to be executed on a knob.

FIG. 7 is a flowchart illustrating an example method for controlling a vehicle.

FIGS. 8A, 8B, 8C, and 8D are schematic diagrams illustrating examples of UIs displayed on a touch display panel of a knob.

FIG. 9 is a schematic diagram illustrating an example position of a knob being attached on a display device.

FIG. 10 is a schematic diagram illustrating an example display UI of FIG. 9 after a layout adjustment.

FIG. 11 is a schematic diagram illustrating an example wallpaper on a display of an audio, video, and navigation (AVN) system.

FIG. 12 shows an example computing system.

### DETAILED DESCRIPTION

Hereinafter, one or more example embodiments of the present disclosure will be described in detail. The example embodiment(s) are implemented based on the technical solution of the present disclosure, and disclose a detailed implementation method and a specific operation process, but the scope of the present disclosure is not limited to the example embodiment(s) described herein.

For purposes of the present application and the claims, using the example phrase “at least one of: A; B; or C” or “at least one of A, B, or C,” the phrase means “at least one A, or at least one B, or at least one C, or any combination of at least one A, at least one B, and at least one C. Further, example phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit" may be configured to be stored in an addressable storage medium, or may be configured to execute one or more processors. The "unit" may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

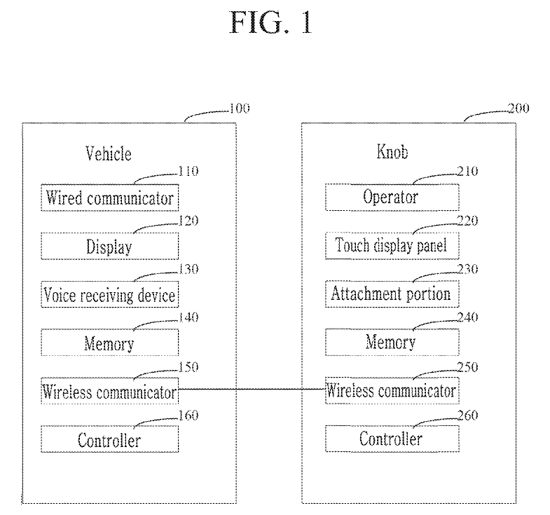

FIG. 1 is a schematic diagram illustrating an example system for controlling a vehicle. Referring to FIG. 1, a system for controlling a vehicle may include a vehicle 100 and a knob 200.

The vehicle 100 may include a wired communicator 110, a display (also referred to as display device) 120, a voice receiving device 130, a memory 140, a wireless communicator 150, and a controller 160.

The wired communicator 110 may exchange data with the controller 160, and the controller 160 may be configured to control multiple control functions within the vehicle. For example, the wired communicator 110 may support vehicle-mounted communication methods such as a controller area network (CAN). Specifically, the wired communicator 110 may transmit control commands received from the controller 160 to an air conditioner controller that controls the air conditioner, a controller that controls a seat, a controller that controls multimedia playback, etc., and the wired communicator 110 may receive operation status information from the controller 160 and transmit the received operation status information to the controller 160.

The display 120 may be intended to visually output the vehicle operation status (e.g., guidance screens of the navigation system, information on the operating status of the air conditioning system, information on the playback status of the multimedia, and various other information required by the driver). For example, the display 120 may include an audio video navigation (AVN) system display, a cluster display, or a head-up display (HUD) installed in the vehicle 100. Alternatively, the display 120 may include a rear seat display installed on the rear surface of the front seat headrest, and there is no limitation on the location or number of the displays 120. When the display 120 is a touch screen, the display 120 may display software buttons (also referred to as user interface (UI) buttons, hereinafter referred to as UI buttons) for controlling some functions and detect touch commands input to the UI buttons.

The voice receiving device 130 may be a microphone. The microphone may be installed inside the vehicle 100. For example, the microphone may be installed on a steering wheel, center console, head lining, or rearview mirror, etc., to receive the voice of the user (e.g., the driver) and output an electrical signal corresponding to the audio input into the microphone. The output electrical signal is transmitted to the controller 160 through the wired communicator 110 and processed by the controller 160 (specifically, voice recognition).

The memory 140 may store the operating system used in the vehicle 100, various application programs running on the operating system, multimedia content, input/output control information of the vehicle, etc.

Data exchange between the vehicle 100 and the knob 200 may be performed by connecting the wireless communicator 150 to a wireless communicator 250 of the knob 200 using a short-range communication protocol (e.g., Bluetooth, ultra-wideband (UWB), etc.).

For example, the wireless communicator (also referred to as (wireless) communication interface or (wireless) communication adapter) 150 of the vehicle 100 may include a UWB antenna and a UWB transmission/reception controller electrically connected to the UWB antenna. The wireless communicator 250 of the knob 200 may include the UWB antenna and the UWB transmission/reception controller (also referred to as UWB transceiver or UWB transceiver circuit) electrically connected to the UWB antenna. In the process of executing data exchange, the UWB transmission/reception controller of the vehicle 100 may transmit information through the UWB antenna of the vehicle 100, and the information may be received by the UWB transmission/reception controller of the knob 200 through the UWB antenna of the knob 200. Similarly, the UWB transmission/reception controller of the knob 200 may transmit information through the UWB antenna of the knob 200, and the information may be received by the UWB transmission/reception controller of the vehicle 100 through the UWB antenna of the vehicle 100.

Additionally, the vehicle 100 may detect the position of the knob 200 through UWB communication between the wireless communicator 150 of the vehicle 100 and the wireless communicator 250 of the knob 200. Specifically, a plurality of UWB antennas of the vehicle 100 are installed at predetermined positions on the vehicle 100 (e.g., four corners of the vehicle 100, an instrument panel region, a roof liner, etc.), so that the distance between the plurality of UWB antennas of the vehicle 100 and the knob 200 may be calculated through the time difference between a request signal transmitted through the plurality of UWB antennas of the vehicle 100 and a response signal received from the plurality of UWB antennas (the response signal is transmitted in response to the UWB transmission/reception controller of the knob 200 receiving the request signal of the UWB antenna of the vehicle 100), and the position of the knob 200 may be accurately detected based on the distance between the plurality of UWB antennas of the vehicle 100 and the knob 200.

The controller (also referred to as control circuit, control circuitry, processor, etc.) 160 may execute overall control over the components of the vehicle 100 and may interact with the knob 200. Specifically, the controller 160 may be implemented as a head unit (HU).

The knob (also referred to as control knob or removable control knob) 200 may include an operator 210 (also referred to as top portion or control knob top portion), a touch display panel 220, an attachment portion (also referred to as bottom portion or control know bottom portion) 230, a memory 240, a wireless communicator 250, and a controller 260.

The memory 240 may store the operating system used in the knob 200, identification information of multiple control functions, UI displayed on the touch display panel 220 according to the control function, and input/output control information of the knob 200, etc.

As described above, the wireless communicator 250 may be connected to the wireless communicator 150 of the vehicle 100 using a short-range communication protocol (e.g., Bluetooth, UWB, etc.), and accordingly, the vehicle 100 may exchange data with the knob 200 and detect the position of the knob 200 (e.g., position of the attachment relative to the display 120).

The controller 260 performs overall control (e.g., operation signal management and display management) for the above-described components and interacts with the vehicle 100.

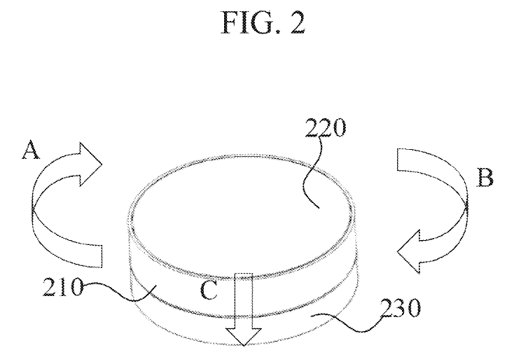

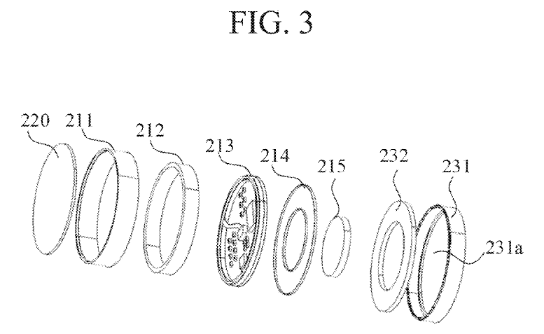

FIG. 2 is a schematic diagram illustrating an example knob, and FIG. 3 is an exploded view of an example knob according. Referring to FIGS. 2 and 3, the operator 210, the touch display panel 220, and the attachment portion 230 included in the knob 200 will be described in detail.

Referring to FIG. 2, the knob (e.g., also referred to as control knob or knob device) 200 may have a cylindrical shape. The knob 200 includes the attachment portion 230 and the operator 210, and the operator 210 is connected to the attachment portion 230 and may be rotated (e.g., rotate with respect to the attachment portion 230) and pressed with respect to the attachment portion 230. Specifically, when the user rotates the operator 210, the operator 210 may rotate in the first rotation direction (e.g., the direction of arrow (A) in FIG. 2) or may rotate in the second rotation direction (e.g., the direction of arrow (B) in FIG. 2). When the user presses the operator 210, the operator 210 may move in a straight direction (e.g., in the direction of arrow (C) in FIG. 2), and when the user stops pressing, the operator 210 may move in the opposite direction of arrow (C) and return to the initial position.

The touch display panel 220 may be provided on the upper surface of the operator 210, and the touch display panel 220 may have a circular shape. However, the actual display region of the touch display panel 220 does not have to correspond to the outer surface of the operator 210 and does not need to have a circular shape. The touch display panel 220 may display a control target or control content to be executed for the control target, and the touch display panel 220 may display a UI button for selecting a control target to be operated or desired control content, and may detect a touch command input to the UI button.

A contact panel 231a may be provided on the bottom surface of the attachment portion 230, and a magnet 232 may be installed on the inner surface of the contact panel 231a. The magnet 232 is attached to a magnetic material portion (e.g., a metal coating layer or a metal plate) installed inside the display 120 of the vehicle 100 (e.g., the rear surface of the display panel) by magnetic force so that the attachment portion 230 including the contact panel 231a may be attached to the display 120 of the vehicle 100. When the attachment portion 230 including the contact panel 231a is attached to the display 120 of the vehicle 100, the upper surface of the operator 210 (e.g., the touch display panel 220) serves as the front surface facing the user, and the outer surface of the contact panel 231a serves as the rear surface in contact with the display 120.

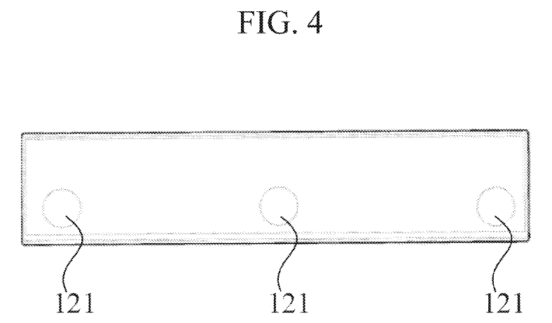

FIG. 4 is a schematic diagram illustrating the rear surface of an example display panel of a display device. As shown in FIG. 4, a plurality (for example, three) of circular magnetic material portions 121 are spaced apart in the lower region of the rear surface of the display panel of the display 120, and the shape of the magnetic material portions 121 may correspond to the outer surface of the contact panel 231a.

The shape of the magnetic material portion 121 does not necessarily have to be circular, and a plurality of magnetic material portions 121 may be formed separately from each other or integrally.

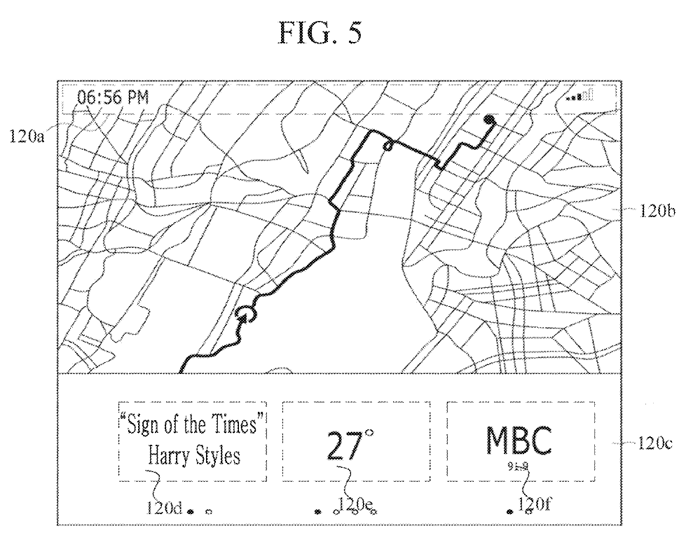

FIG. 5 is a schematic diagram illustrating an example map displayed on the display device. As shown in FIG. 5, the display 120 of the vehicle may generally be divided into a plurality of regions according to the display function. For example, status information may be displayed in the top area 120a. An upper region 120b immediately below the top region 120a may have the largest area in the display 120. Below the upper region 120b, a lower region 120c is provided to display a plurality of control functions. For example, the lower region 120c includes a UI button 120d for a multimedia playback control function, a UI button 120e for an air conditioner control function, and a UI button 120f for a broadcast channel control function. A user may control various control functions by touching the UI button 120d or the UI button 120f. Therefore, the lower region 120c is the most appropriate position for attaching the knob 200 and is the attachment position generally chosen by drivers. Accordingly, in response to this, the magnetic material portion 121 is installed in the lower region of the rear surface of the display panel.

When the knob 200 is attached to the display 120 of the vehicle 100, the magnet 232 may be attached to the entire magnetic material portion 121 or to only a portion of the magnetic material portion 121. In this case, the size of the magnetic force generated by the magnetic force may still be greater than the rotational resistance of the operator 210, and the vibration generated while the vehicle 100 is traveling does not cause the knob 200 to deviate and thus slippage is prevented.

As described above, through UWB communication between the wireless communicator 150 of the vehicle 100 and the wireless communicator 250 of the knob 200, the vehicle 100 may detect the position of the knob 200. That is, the vehicle 100 may identify whether the knob 200 is attached to the display 120 of the vehicle 100 and the position at which the knob 200 is attached on the display 120. For example, the knob 200 may be attached to the left side of the lower region of the display 120.

Referring to FIG. 3, the operator 210 includes a dial 211 and an intermediate shaft 212, and the attachment portion 230 includes a base 231. The dial 211 has a hollow shape and surrounds the touch display panel 220. That is, the touch display panel 220 is mounted on the dial 211. The intermediate shaft 212 is connected to and affixed to the base 231, the dial 211 is installed on the outside of the intermediate shaft 212, and the dial 211 may rotate around the intermediate shaft 212 and move along the intermediate shaft 212. A return structure (e.g., elastic body, etc.; not shown) is provided on the intermediate shaft 212 so that when the force pressing the dial 211 disappears, the dial 211 may return to its original position. The contact panel 231a is provided on the bottom surface of the base 231, and the magnet 232 is installed on the inner surface of the bottom surface of the base 231. The bottom surface of the base 231 and the contact panel 231a are formed integrally so that the bottom surface of the base 231 may function as the contact panel 231a.

The operator 210 further includes a circuit board 213, and the circuit board 213 is installed between the intermediate shaft 212 and the base 231. Specifically, the circuit board 213 may be a printed circuit board (PCB).

The circuit board 213 may be provided with a detector for detecting rotation and/or pressing of the dial 211. The dial 211 may rotate around the center in the axial direction or move in the axial direction. When the user rotates or presses the dial 211, the circuit board 213 is configured to detect at least one of the rotation direction and rotation degree (e.g., displacement or angle) of the dial 211 and the pressing force. It should be noted that the example embodiment(s) of the present disclosure do not limit a specific detector or a specific detection method for detecting rotation and pressing of the dial 211.

Additionally, the memory 240, the wireless communicator 250, and the controller 260 are installed on the circuit board 213. Specifically, the controller 260 may be implemented as a microcontroller unit (MCU) on the circuit board 213. The wireless communicator 250 includes the UWB antenna and the UWB transmission/reception controller electrically connected to the UWB antenna. The circuit board 213 may further include other electronic components such as a power circuit.

At this time, since the magnet 232 is provided at the bottom of the circuit board 213, the knob 200 may further include a circuit board protection cover 214 to shield the magnetic force of the magnet 232. The circuit board protection cover 214 is installed between the circuit board 213 and the magnet 232, and the circuit board protection cover 214 may be shaped to match the shape of the magnet 232.

To facilitate charging of the knob 200, the knob 200 may further include a wireless charging coil 215. The wireless charging coil 215 is disposed closer to the wireless charging transmitter disposed on the inner surface of the contact panel 213a—outside the knob 200—to prevent poor charging contact. Specifically, the wireless charging coil 215 is electrically connected to the power circuit of the circuit board 213. The circuit board protection cover 214 and the magnet 232 may be formed in a ring shape, and the wireless charging coil 215 is installed between the circuit board 213 and the base 231 by being disposed in the center of the circuit board protection cover 214 and the magnet 232.

The knob 200 may implement three modes: the multi-function knob mode (also referred to as multi-function mode or multi-function control knob mode), the remote-control mode, and the smart key mode. A user may choose one of the three modes.

Specifically, an application (APP) may be configured in the controller 160 of the vehicle 100, and the APP corresponds to a function that may be executed in the knob 200. The controller 160 of the vehicle 100 may control the display 120 to display an APP icon, and the user may touch the APP icon to enter a UI window, and in the UI window, the user may select a function that may be executed on the knob 200.

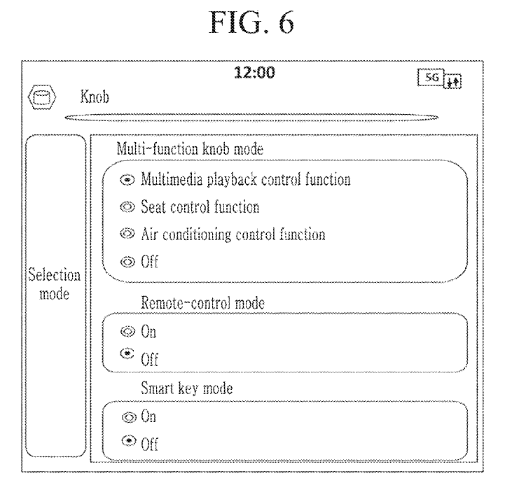

FIG. 6 is a schematic diagram illustrating an example user interface (UI) window provided to allow a user to select a function to be executed on a knob. As shown in FIG. 6, the modes of the knob 200 include the multi-function knob mode, the remote-control mode, and the smart key mode. Under multi-function knob mode, there are four options: “multimedia playback control function,” “seat control function,” “air conditioning control function”, and “off.”

The user may turn on multi-function knob mode by touching the display 120 to select one of the options: “multimedia playback control function,” “seat control function,” and “air conditioning control function.”

Conversely, if the user touches the display 120 to select the “off” option, multi-function knob mode is turned off. Under remote-control mode and smart key mode, there are two options, “on” and “off,” and the user may select the “on” or “off” option by touching the display 120.

That is, the display 120 may be used as a user input device for receiving user input. Alternatively, the voice receiving device 130 may be used as the user input device. The user may select between multi-function knob mode, remote-control mode, and smart key mode by speaking. For example, the user may turn on remote-control mode by saying “remote-control mode on.”

Accordingly, the controller 160 of the vehicle 100 may receive a user input signal regarding the mode of the knob 200 from the user input device, and, based on the received user input signal regarding the mode of the knob 200, may transmit a corresponding knob mode switching signal to the knob 200 so that the mode of the knob 200 may be switched to one of multi-function knob mode, remote-control mode, and smart key mode.

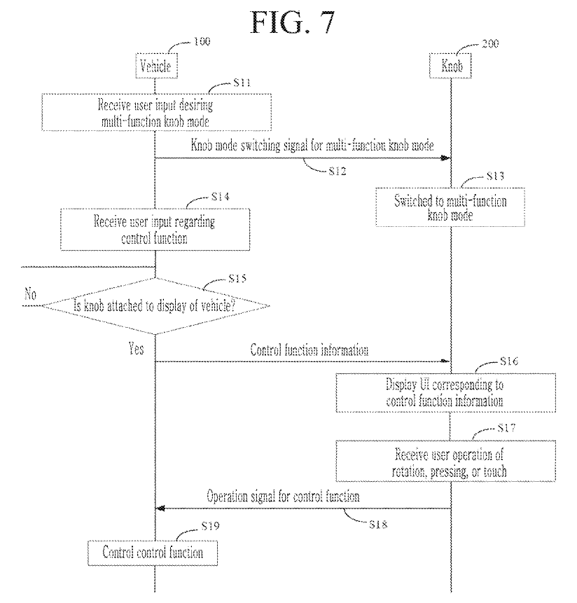

FIG. 7 is a flowchart illustrating an example method for controlling a vehicle. Hereinafter, with reference to FIG. 7, the operation process of the system for controlling the vehicle will be described in detail, wherein the mode of the knob 200 is switched to multi-function knob mode.

The vehicle 100 may receive user input desiring multi-function knob mode (S11).

Based on the user input requesting the received multi-function knob mode, the controller 160 of the vehicle 100 may transmit the knob mode switching signal for multi-function knob mode to the knob 200 through the wireless communicator 150 (S12). When the controller 260 of the knob 200 receives the knob mode switching signal for multi-function knob mode through the wireless communicator 250, the knob 200 may be switched to multi-function knob mode (S13).

At least in some implementations, there was a problem in that the UI button of the large screen display 120 was far away from the user, making it difficult for the user to easily operate the UI button from the seat. The multi-function knob mode of the knob 200 of the present disclosure is intended to solve the above-noted problem.

For example, referring to FIG. 5, if the driver sits on the left side of the vehicle 100, the driver may not be able to touch the UI button 120f of the display 120 which is far away from the driver. At this time, the driver may operate the knob 200 by attaching the knob 200 near the UI button 120d of the display 120 (e.g., a region close to the driver) and switching the mode of the knob 200 to the multi-function button mode. Accordingly, touch input on the UI buttons 120d, 120e, and 120f of the display 120 may be replaced by the operation of the knob 200. In this case, if the user's knob 200 operation is intended to replace only the touch on the UI button 120f of the display 120, the UI buttons 120d, 120e, and 120f each correspond to different control functions, the user must select the control function corresponding to the UI button 120f among the control functions corresponding to the UI buttons 120d, 120e, and 120f.

Accordingly, the controller 160 of the vehicle 100 may receive user input regarding the control function (S14). Specifically, user input regarding the control function may be user input regarding the type of control function. Types of control functions may include seat control functions, multimedia playback control functions, air conditioning control functions, and broadcast channel control functions.

As shown in FIG. 6, the “multimedia playback control function” option corresponds to the multimedia playback control function, the “seat control function” option corresponds to the seat control function, and the “air conditioning control function” option corresponds to the air conditioning control function. As described above, the user may select one of these options by touching the display 120.

However, while the vehicle is traveling, the user often needs to control each control function frequently, and it may be inconvenient to touch and select each time. Therefore, in the same manner as the user input method in step (S11), the user may select the type of control function by speaking. For example, the user may select the “air conditioning control function” by saying “select air conditioning control function.”

In multi-function knob mode, the knob 200 is intended to replace the UI button of the display 120, so in the multi-function button mode, the button 200 must be attached to the display 120 of the vehicle 100, and the vehicle 100 must detect whether the knob 200 is attached to the display 120.

If the controller 160 of the vehicle 100 receives user input regarding the control function, the controller 160 of the vehicle 100 may detect the position of the knob 200 and whether the knob 200 is attached to the display 120 of the vehicle 100 (S15). Specifically, as described above, the vehicle 100 may accurately detect the position of the knob 200 through UWB communication between a plurality of UWB antennas of the vehicle 100 and the UWB antenna of the knob 200. Additionally, the position of at least one display 120 of the vehicle 100 is stored in advance in the memory 140 of the vehicle 100. The controller 160 of the vehicle 100 may compare the position of the detected knob 200 with the position of at least one display 120 stored in advance to detect whether the knob 200 is attached to at least one display 120 of the vehicle 100.

If the controller 160 of the vehicle 100 detects that the knob 200 is not attached to the display 120 of the vehicle 100 (“No” in step (S15)), the controller 160 does not respond to user input regarding the received control function. At this time, even if the knob 200 is switched to multi-function knob mode, the vehicle 100 does not respond even if the user selects a specific control function (e.g., air conditioner control function), the knob 200 cannot be used for the air conditioner control function, and the user cannot operate the knob 200.

When the controller of the vehicle 100 detects that the knob 200 is attached to the display 120 of the vehicle 100 (“Yes” in step (S15)), the controller 160 of the vehicle 100 may transmit control function information to the knob 200 in response to the user input regarding the received control function (S16). Specifically, the controller 160 of the vehicle 100 transmits control function information through the wireless communicator 150.

The controller 260 of the knob 200 may receive control function information through the wireless communicator 250. The knob 200 may display a UI corresponding to the control function information on the touch display panel 220 based on the received control function information (S16).

The control function information may include the type of control function, and in this case, the UI corresponding to the control function information may include an icon indicating the type of control function.

The control function information may further include the current state information of the control function. In this case, the UI corresponding to the control function information may include a number, text, or symbol indicating the current state of the control function.

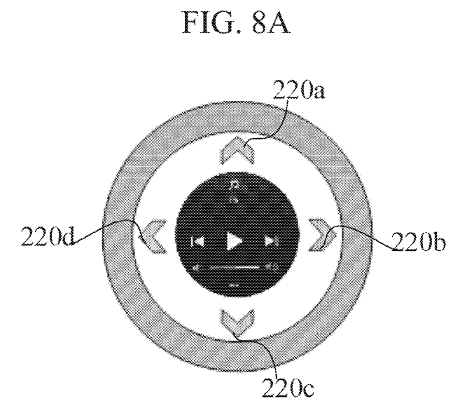

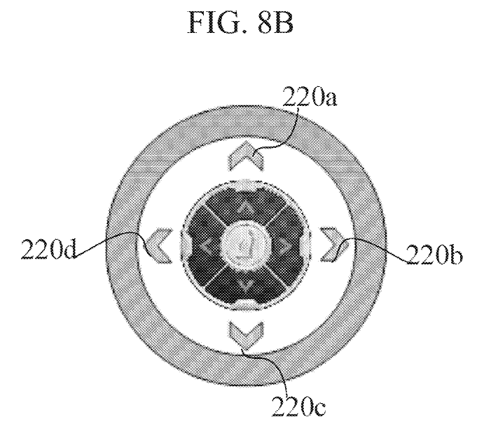

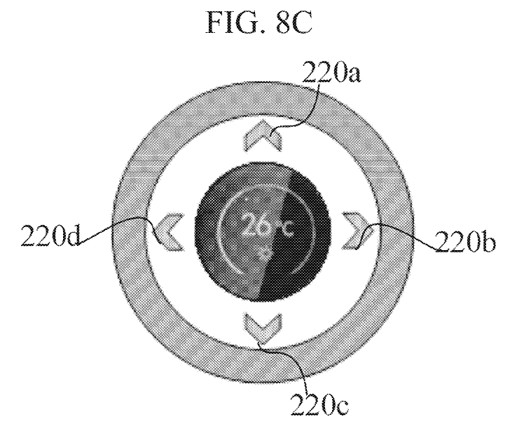

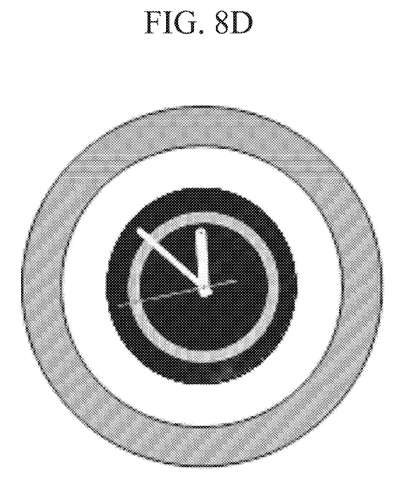

FIGS. 8A, 8B, 8C, and 8D are schematic diagrams illustrating examples of UIs displayed on the touch display panel of the knob.

As shown in FIG. 8A, the center of the touch display panel 220 of the knob 200 may display current status information of the multimedia playback control function, such as the currently playing track and the current playback volume.

As shown in FIG. 8B, an icon indicating the seat control function may be displayed in the center of the touch display panel 220 of the knob 200.

As shown in FIG. 8C, the current mode and current set temperature of the air conditioner, which are current status information of the air conditioner control function, may be displayed in the center of the touch display panel 220 of the knob 200.

Referring to FIGS. 8A to 8C, in addition to the control function information that may be displayed on the touch display panel 220, the touch display panel 220 may further include at least one UI button—for example, UI buttons 220a, 220b, 220c, or 220d.

As shown in FIG. 8D, when the knob 200 cannot receive control function information from the vehicle 100, the touch display panel 220 of the knob 200 may display a clock icon. This may be a sleep mode of the knob 200.

As described above, the user's operation of the knob 200 may include rotation or pressing of the operator 210, or touching the touch display panel 220. When the knob 200 receives a user operation (S17), the knob 200 may transmit an operation signal for a control function to the vehicle 100 (S18). Specifically, the controller 260 of the knob 200 may transmit the operation signal for the control function to the vehicle 100 through the wireless communicator 250. For example, the controller 260 may transmit, to the vehicle, an operation signal corresponding to a user input received by the operator 210. The user input received by the operator 210 may include, for example, one or more of: a rotation of the operator 210 (e.g., by a user), a press of the operator 210 (e.g., by a user), and/or a touch input (e.g., by a user) on the touch display panel 220.

After the controller 160 of the vehicle 100 receives the operation signal for the control function through the wireless communicator 150, the vehicle 100 may control a corresponding control function based on the operation signal for the control function (S19).

For example, as shown in FIG. 8A, the currently playing track and the current playback volume are displayed on the touch display panel 220 of the knob 200 for the multimedia playback control function.

In this case, if the dial 211 is rotated clockwise, the playback volume of the multimedia may increase depending on the rotation amount. When the dial 211 is rotated counterclockwise, the multimedia playback volume may be reduced depending on the rotation amount.

To achieve the above-described effect, the controller 260 of the knob 200 may calculate the target volume value according to the current playback volume and the rotation amount and rotation direction of the dial 211. The controller 260 of the knob 200 may transmit the target volume value to the vehicle 100 as an operation signal for the multimedia control function through the wireless communicator 250. The controller 160 of the vehicle 100 may receive the target volume value through the wireless communicator 150. The controller 160 of the vehicle 100 may transmit a control command regarding the target volume value to the AVN system through the wired communicator 110. The AVN system may increase or decrease the multimedia playback volume to a target volume value according to the received control command. Additionally, the knob 200 may display status information changes of the control function through the touch display panel 220. That is, the current playback volume displayed on the touch display panel 220 may be changed to the target volume value after rotating the dial 211.

When the UI button 220b is touched, the track being played in the multimedia may be changed to the next track in the track playlist. When the UI button 220d is touched, the track being played in the multimedia may be changed to the previous track in the track playlist.

To achieve the above-described effect, the controller 260 of the knob 200 may generate an operation signal for changing a track played in the multimedia according to a touch signal input to the UI button 220b or the UI button 220d. The controller 260 of the knob 200 may transmit an operation signal to the vehicle 100 to change the track played in the multimedia through the wireless communicator 250. The controller 160 of the vehicle 100 may transmit a control command to change the track played in the multimedia to the AVN system through the wired communicator 110. The AVN system changes the track being played in the multimedia to the next or previous track in the track playlist according to the received control command. Additionally, the currently playing track of multimedia displayed on the touch display panel 220 of the knob 200 may be changed to the track being played after the UI button 220b or the UI button 220d is touched.

While playing a track, pressing the dial 211 may stop the track from playing, and pressing the dial 211 again may continue playback of the track from where the playback was stopped.

To achieve the above-described effect, the controller 260 of the knob 200 may generate an operation signal for changing the playback state of the track according to the current playback state of the track (e.g., play or play stop) and the pressing signal of the dial 211. The controller 260 of the knob 200 may transmit an operation signal to the vehicle 100 to change the playback status of the track through the wireless communicator 250. The controller 160 of the vehicle 100 may transmit a control command to change the playback status of the track to the AVN system through the wired communicator 110. The AVN system may stop or continue the track depending on the received control command. Additionally, the current playback status of multimedia displayed on the touch display panel 220 of the knob 200 may be changed by pressing the dial 211.

As shown in FIG. 8B, an icon indicating a seat control function is displayed on the touch display panel 220 of the knob 200. In this state, if the dial 211 is rotated clockwise, the air volume of the seat may increase according to the rotation amount, and if the dial 211 is rotated counterclockwise, the air volume of the seat may decrease according to the rotation amount. By pressing the dial 211, the seat position may be adjusted. When one of the UI buttons 220a, 220b, 220c, or 220d is touched, the angle or height of the seat may be adjusted.

As shown in FIG. 8C, the current mode and current set temperature of the air conditioner control function are displayed on the touch display panel 220 of the knob 200. In this case, if the dial 211 is rotated clockwise, the set temperature of the air conditioner may be increased according to the rotation amount, and if the dial 211 is rotated counterclockwise, the set temperature of the air conditioner may be decreased according to the rotation amount. By pressing the dial 211, the mode of the air conditioner may be changed. When the UI button 220b is touched, the air volume of the air conditioner may increase, and when the UI button 220d is touched, the air volume of the air conditioner may decrease.

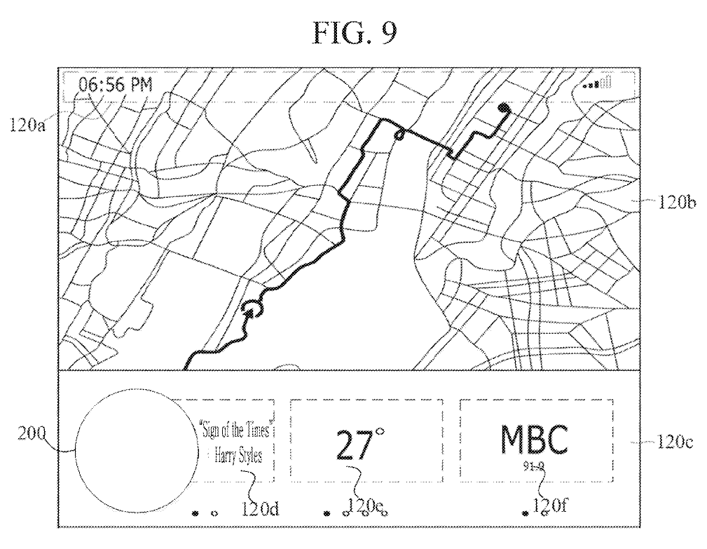

Therefore, referring to FIG. 5, if the driver cannot touch the UI button 120f which is far away from the driver on the display 120, the driver may attach the knob 200 to a region of the display 120 that is closer to the driver. FIG. 9 is a schematic diagram illustrating an example position of the knob 200 being attached to the display 120. As shown in FIG. 9, the position of the knob 200 attached to the display 120 is the left part of the lower region 120c of the display 120. When the knob 200 is attached to the display 120, the driver may switch the knob 200 to a multi-function button mode, and additionally select a broadcast channel control function, and then replace the touch on the UI button 120f of the display 120 by operating the knob 200. In addition, since the knob 200 has a hardware button structure, the operational feel when rotating or pressing the knob 200 is better than the operational feel when touching the UI button.

However, as shown in FIG. 9, the position of the knob 200 on the display 120 obscures the UI button 120d, and also obscures the currently playing track displayed in the region where the UI button 120d is disposed. This not only prevents the driver from directly touching the UI button 120d to control the multimedia playback control functions, but also makes it harder for the driver to obtain information about the currently playing track from the display 120.

To solve the above-noted problem, if the controller 160 of the vehicle 100 detects that the knob 200 is attached to the display 120, the controller 160 of the vehicle 100 may detect the position of the knob 200 attached on the display 120, and, according to the position of the knob 200 attached on the display 120, adjust the UI layout of the display 120 so that the knob 200 does not obscure specific information on the UI. Specific information may refer to UI buttons or text, icons, numbers, symbols, or the like.

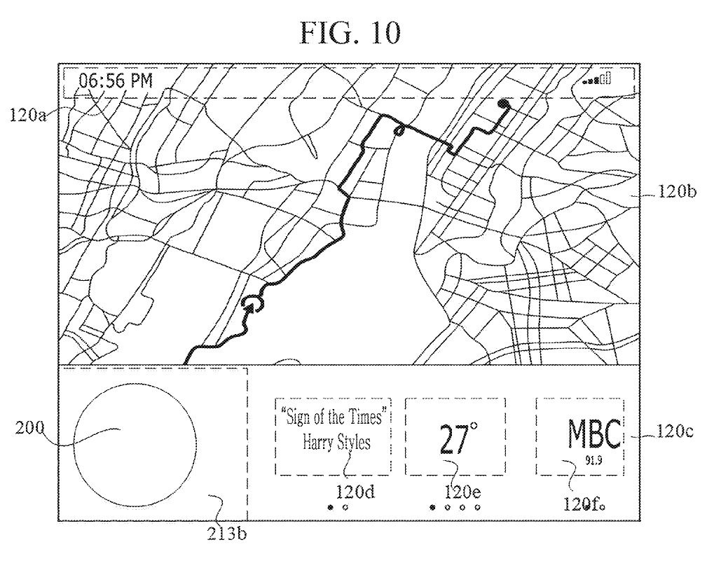

FIG. 10 is a schematic diagram illustrating an example display UI of FIG. 9 after a layout adjustment. As shown in FIG. 10, the position of the knob 200 attached to the display 120 may be represented by the circular position of the contact panel 231a in contact with the display 120 on the display 120. The controller 160 of the vehicle 100 may determine the position of a rectangle 213b including the circular shape according to the position of the circular shape.

That is, the rectangle 213b is set to cover the entire circular shape. After determining the position of the rectangle 213b, the controller 160 of the vehicle 100 removes the UI range corresponding to the position of the rectangle 213b from the UI range of the display 120 to obtain a new UI range. The vehicle 100 may adaptively adjust the layout of the UI buttons 120d, 120e, and 120f according to the new UI range. For example, the UI buttons 120d, 120e, and 120f may be adjusted to the right side of the lower region 120c so that the position of the knob 200 on the display 120 does not obscure the UI button 120d and the currently playing track displayed in the region where the UI button 120d is disposed.

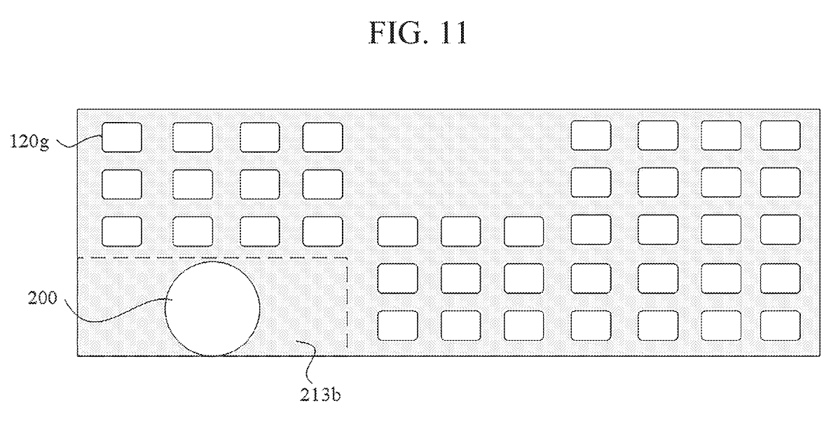

In another example, FIG. 11 is a schematic diagram illustrating an example wallpaper on a display of the AVN system. As shown in FIG. 11, the UI displaying the desktop of the AVN system display includes a plurality of APP icons 120g. Similarly, the controller 160 of the vehicle 100 removes the UI range corresponding to the position of the rectangle 213b from the UI range of the display 120 and adaptively adjusts the APP icon 120g according to the new UI range.

In addition, there is no need to readjust the background pattern of the UI. For example, if the wallpaper background is a gray pattern, the interior of the rectangle 213b may still have a gray pattern so that the knob 200 may be better integrated into the display 120 and provide a good visual effect to the user.

Hereinafter, the operation process of a system for controlling a vehicle including the knob 200 will be described with a focus on switching the mode of the knob 200 to remote-control mode and smart key mode.

When the controller 160 of the vehicle 100 receives a user input signal desiring remote-control mode, the controller 160 of the vehicle 100 transmits a knob mode (also referred to as control knob mode) switching signal for remote-control mode through the wireless communicator 150. When the knob 200 receives a knob mode switching signal for remote-control mode from the vehicle 100 through the wireless communicator 250, the knob 200 (e.g., an operation mode of the knob 200) may be switched to remote-control mode.

If the knob 200 (e.g., an operation mode of the knob 200) is switched to remote-control mode, the knob 200 is not attached to the display 120 of the vehicle 100 and is not used, and the knob 200 may be held in the user’s hand. Therefore, in remote-control mode, the user may remotely control the functions of the AVN system or entertainment information system (e.g., applications and functions such as radio, Bluetooth music, navigation, local music, etc.) in a more comfortable position on the seat. Correspondingly, the controller 260 of the knob 200 may control the touch display panel 220 to display various UI buttons for implementing the above-described functions.

Additionally, the knob 200 in remote-control mode may be attached to the center console of the vehicle 100. At this time, the knob 200 may be used as a center control panel (CCP), and the touch display panel 220 of the knob 200 may be implemented as a transparent touch display panel.

When the controller 160 of the vehicle 100 receives user input signal desiring smart key mode, the controller 160 of the vehicle 100 transmits a knob mode switching signal for smart key mode through the wireless communicator 150. When the knob 200 receives a knob mode switching signal for smart key mode from the vehicle 100 through the wireless communicator 250, the knob 200 may be switched to smart key mode.

The knob 200 and the vehicle 100 communicate through UWB, and the vehicle 100 detects the position of the knob 200 through UWB communication with the knob 200, so the knob 200 satisfies the conditions for replacing a smart key. When the user approaches the vehicle 100 with the knob 200, the user may unlock the door from outside the vehicle 100 using the knob 200. Alternatively, when the user is carrying the knob 200 and moving away from the vehicle 100, the user may use the knob 200 to lock the door from outside the vehicle 100.

Correspondingly, the controller 260 of the knob 200 may control the touch display panel 220 to display various UI buttons for the smart key function.

A method for controlling a vehicle is provided herein. In the method for controlling the vehicle, the vehicle is the vehicle 100 illustrated in FIG. 1, and in the method for controlling the vehicle, the knob is the knob 200 illustrated in FIGS. 1 to 3. The method for controlling a vehicle may include transmitting a corresponding knob mode switching signal to the knob 200 by the vehicle 100 based on user input regarding the received knob mode, when the vehicle 100 transmits a knob mode switching signal for multi-function knob mode to the knob 200, switching (e.g., switching an operation mode of the knob 200) to multi-function knob mode by the knob 200 based on the knob mode switching signal for multi-function knob mode received from the vehicle 100, based on the user input regarding the control function received by the vehicle 100, transmitting corresponding control function information to the knob 200 attached to the display 120 by the vehicle 100, based on the control function information received by the vehicle 100, displaying a user interface corresponding the control function information to the touch display panel 200 by the knob 200 attached to the display 120, when the knob 200 attached to the display 120 receives the user’s operation, transmitting a control signal for the control function to the vehicle 100 by the knob 200 attached to the display 120, and based on the operation signal for the control function received from the knob 200, a step of controlling a corresponding control function by the vehicle 100.

If the vehicle 100 receives the user input regarding the control function, the vehicle 100 detects whether the knob 200 is attached to the display 120, when the vehicle 100 detects that the knob 200 is attached to the display 120, the vehicle 100 transmits corresponding control function information to the knob 200 based on the received user input regarding the control function, and when the vehicle 100 detects that the knob 200 is not attached to the display 120, the vehicle 100 does not respond to the user input regarding the control function received by the vehicle 100.

The vehicle 100 detects the position of the knob 200 attached to the display 120, and, based on the detected position of the knob 200 attached to the display 120, the vehicle 100 adjusts the UI layout of the display 120 so that the knob 200 does not obscure specific information (e.g., UI buttons or text, icons, numbers, symbols, etc.) on the UI.

The mode of the knob 200 may have a remote-control mode and a smart key mode.

Specifically, if the vehicle 100 transmits a knob mode switching signal for remote-control mode to the knob 200, the knob 200 (e.g., an operation mode of the knob 200) may be switched to the remote-control mode based on the knob mode switching signal for remote-control mode received from the vehicle 100. In remote-control mode of the knob 200, the user may remotely control the functions of the AVN system or entertainment information system in a more comfortable position on the seat.

When the vehicle 100 transmits a knob mode switching signal for smart key mode to the knob 200, the knob 200 switches to smart key mode based on the knob mode switching signal for smart key mode received from the vehicle 100. In smart key mode of the knob 200, the user may use the knob 200 to execute smart key functions such as unlocking or locking the door.

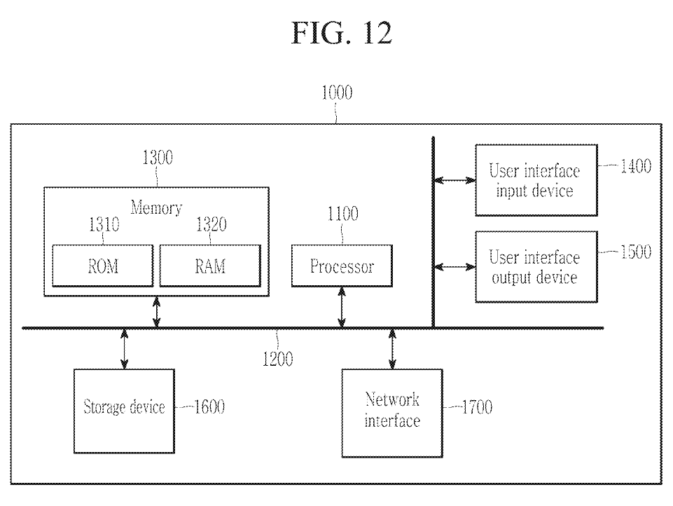

FIG. 12 shows an example computing system (e.g., a computing device of a vehicle or any other apparatus). One or more controllers, processors, etc. described herein (e.g., the vehicle 100, the knob 200, the controller 160, the controller 260, etc.) may be implemented by the computing system or may be implemented in the computing system.

A computing system (also referred to as a computer, a computing device, etc.) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable read-only memory (EPROM), an electrically erasable and programmable read-only memory (EEPROM), a register, a hard disk drive, a removable disc, or a compact disc read-only memory (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to the present disclosure, a knob is provided. The knob may include an attachment portion, an operator, and a controller, wherein a contact panel is provided on the bottom surface of the attachment portion, a magnet is installed on an inner surface of the contact panel, and the magnet is configured to be attached to a magnetic material portion installed inside the display of the vehicle by magnetic force, the operator is configured to be connected to the attachment portion and to be rotated and pressed with respect to the attachment portion, and a touch display panel is provided on an upper surface of the operator, and the controller is configured to switch to one of multi-function knob mode, remote-control mode, and a smart key mode based on a knob mode switching signal received from the vehicle, when switched to the multi-function knob mode, displays a user interface corresponding to control function information on the touch display panel based on the control function information received from the vehicle, and transmits an operation signal for a control function to the vehicle when the operator is rotated or pressed, or when the display panel is touched.

The control function information may include a type of control function, and the type of control function may include at least a seat control function, a multimedia playback control function, and an air conditioning control function.

The knob may further include a wireless communicator, wherein the controller may be configured to receive the knob mode switching signal and control function information from the vehicle through the wireless communicator, and to transmit the operation signal for the control function to the vehicle through the wireless communicator.

The wireless communicator may include an ultra-wideband antenna and an ultra-wideband transmission/reception controller electrically connected to the ultra-wideband antenna.

A wireless charging coil may be installed on the inner surface of the contact panel.

According to the present disclosure, a vehicle is provided. The vehicle may include a display and a controller, wherein a magnetic material portion is installed inside the display, and the magnetic material portion is configured to attach a magnet installed in the knob by magnetic force, and the controller is configured to: transmit, based on a user input signal regarding a knob mode, a corresponding knob mode switching signal to the knob; when a knob mode switching signal for multi-function knob mode is transmitted to the knob, transmit, based on a user input signal regarding a control function, corresponding control function information to the knob attached to the display; and control, based on an operation signal for the control function received from the knob attached to the display, the corresponding control function.

The controller may be configured to detect whether the knob is attached to the display when the user input signal regarding the control function is received, based on detecting that the knob is attached to the display, transmit the corresponding control function information to the knob based on the user input signal regarding the received control function, and not respond to the user input signal regarding the received control function based on detecting that no knob is attached to the display.

The controller may be configured to detect a position of the knob attached to the display, and adjust a layout of the user interface of the display based on the detected position of the knob attached to the display so that the knob does not obscure specific information on the user interface.

The control function information may include a type of control function, wherein the type of control function may include at least a seat control function, a multimedia playback control function, and an air conditioning control function.

A system of controlling a vehicle is provided. The system may include a vehicle including a display, and a knob attachable to the display of the vehicle, wherein the vehicle transmits a corresponding knob mode switching signal to the knob based on the user input regarding the received knob mode, when the vehicle transmits the knob mode switching signal for multi-function knob mode to the knob, the knob switches to multi-function knob mode based on the knob mode switching signal for multi-function knob mode received from the vehicle, the vehicle transmits corresponding control function information to a knob attached to the display based on user input regarding the received control function, the knob attached to the display displays a user interface corresponding to the control function information on the touch display panel based on the control function information received from the vehicle, when the knob attached to the display receives user operation, the knob transmits an operation signal for the control function to the vehicle, and the vehicle may control the corresponding control function based on the operation signal for the control function received from the knob attached to the display.

When the vehicle transmits the knob mode switching signal for remote-control mode to the knob, the knob may be switched to remote-control mode based on the knob mode switching signal for remote-control mode received from the vehicle.

When the vehicle transmits the knob mode switching signal for smart key mode to the knob, the knob may be switched to smart key mode based on the knob mode switching signal for smart key mode received from the vehicle.

The knob may include an attachment portion, a contact panel may be provided on the bottom surface of the attachment portion, a magnet may be installed on the inner surface of the contact panel, and a magnetic material portion may be installed inside the display of the vehicle, the magnet may be attached to the magnetic material portion by magnetic force so that the knob is attachable to the display of the vehicle.

The knob may include an operator, the operator may be configured to be connected to the attachment portion and to be rotated and pressed with respect to the attachment portion, and the touch display panel may be provided on the upper surface of the operator, and the user operation received by the knob may include rotation or pressing of the operator, or touch of the touch display panel.

The vehicle may be configured to detect whether the knob is attached to the display of the vehicle by the vehicle when the vehicle receives user input regarding a control function, based on detecting that the knob is attached to the display of the vehicle, transmit corresponding control function information to the knob by the vehicle based on user input regarding the received control function, and not respond to user input regarding control function received by the vehicle based on detecting that the knob is not attached to the display of the vehicle.

The vehicle may be configured to detect the position of the knob attached to the display, and adjust the layout of the user interface of the display so that the knob does not obscure specific information on the user interface of the display by the vehicle, according to the detected position of the knob attached to the display of the vehicle.

The vehicle may be configured to detect the position of the knob through ultra-wideband communication between the vehicle and the knob to determine whether the knob is attached to the display and the position of the knob attached to the display.

The control function information may include a type of control function, and the type of control function may include at least a seat control function, a multimedia playback control function, and an air conditioning control function.

A method for controlling a vehicle is provided. The method may include receiving a user input requesting a switch to a multi-function knob mode by the vehicle, switching a knob to the multi-function knob mode by transmitting a knob mode switch signal for the multi-function knob mode to the knob by the vehicle, based on receiving the user input requesting the switch to the multi-function knob mode, receiving a user input regarding a control function by the vehicle, based on receiving the user input regarding the control function, transmitting corresponding control function information to the knob attached to a display of the vehicle by the vehicle to display a user interface corresponding to the control function information on a touch display panel of the knob, receiving an operation signal for the control function corresponding to a user operation by a vehicle from a knob, and controlling a corresponding control function by the vehicle based on the operation signal for the control function received from a knob.

The method may further include receiving user input requesting a switch to remote-control mode by the vehicle, and based on receiving the user input requesting a switch to the remote-control mode, transmitting a knob mode switching signal for the remote-control mode to the knob by the vehicle to switch the knob to the remote-control mode.

The method may further include receiving the user input requesting a switch to smart key mode by the vehicle, and based on receiving the user input requesting the switch to the smart key mode, transmitting a knob mode switching signal for the smart key mode to the knob by the vehicle to switch the knob to the smart key mode.

The method may further include detecting whether the knob is attached to the display of the vehicle by the vehicle when the vehicle receives the user input regarding the control function, based on detecting that the knob is attached to the display of the vehicle, transmitting the corresponding control function information to the knob by the vehicle based on the user input regarding the received control function, and not responding to the user input regarding the control function received by the vehicle based on detecting that the knob is not attached to the display of the vehicle.

The method may include detecting the position of the knob attached to the display of the vehicle by the vehicle, and adjusting the layout of the user interface of the display so that the knob does not obscure specific information on the user interface of the display by the vehicle, according to the detected position of the knob attached to the display of the vehicle.

The knob may include an attachment portion, a contact panel may be provided on a bottom surface of the attachment portion, a magnet may be installed on the inner surface of the contact panel, and a magnetic material portion may be installed inside the display of the vehicle, wherein the magnet may be attached to the magnetic material portion by magnetic force so that the knob is attachable to the display of the vehicle.

The knob may include an operator, the operator may be configured to be connected to the attachment portion and to be rotated and pressed with respect to the attachment portion, and the touch display panel may be provided on the upper surface of the operator, wherein the user operation received by the knob may include rotating or pressing the operator, or touching the touch display panel.

In the multi-function knob mode, the user may place the knob at a convenient position for operation on the vehicle display. Therefore, the problem wherein the UI buttons on the display are far away from the user and the user cannot easily operate the UI buttons from the seat may be solved. Additionally, since the knob has a hardware button structure, the operational feel when rotating or pressing the knob is better than the operational feel when touching the UI button.

The knob may have a remote-control mode and a smart key mode. In remote-control mode, the user may remotely control the functions of the AVN system or entertainment information system in a more comfortable position on the seat, and in smart key mode, the user may use the knob to execute smart key functions such as unlocking or locking the door.

The example embodiment(s) of the present disclosure do not enumerate all possible combinations, but rather describe representative aspects of the present disclosure, and furthermore, the contents described in the example embodiment(s) may be applied independently or in a combination of two or more.

While the example embodiment(s) of the present disclosure have been described in detail, it is to be understood that the disclosure is not limited to the disclosed example embodiment(s), but on the contrary, is intended to cover various modifications and equivalent arrangements included within the spirit and scope of the appended claims.

What is claimed is:

1. A control knob of a vehicle, the control knob comprising:
a bottom portion comprising:
a contact panel provided on a bottom surface of the bottom portion, and
a magnet installed on an inner surface of the contact panel, wherein the magnet is configured to attach, by magnetic force, to a magnetic material installed inside a display of the vehicle;
a top portion configured to:
connect to the bottom portion,
rotate with respect to the bottom portion, and
be pressed with respect to the bottom portion,
wherein the top portion comprises a touch display panel provided on an upper surface of the top portion; and
a controller circuit configured to:
switch, based on receiving a control knob mode switching signal from the vehicle, an operation mode of the control knob to one of: a multi-function mode, a remote-control mode, or a smart key mode;
display, on the touch display panel and based on the control knob being switched to the multi-function mode, a user interface corresponding to control function information received from the vehicle; and
transmit, to the vehicle and based on a user input received by the top portion, an operation signal for a control function corresponding to the user input, wherein the user input comprises at least one of: a rotation of the top portion, a press of the top portion, or a touch input on the touch display panel.

2. The control knob of claim 1, wherein the control function information comprises a control function type, and wherein the control function type comprises at least one of: a seat control function, a multimedia playback control function, or an air conditioning control function.

3. The control knob of claim 1, wherein the control knob further comprises a wireless communication interface, and
wherein the controller circuit is further configured to:
receive, from the vehicle via the wireless communication interface, the control knob mode switching signal and the control function information, and
wherein the controller circuit is configured to transmit the operation signal by:
transmitting the operation signal to the vehicle via the wireless communication interface.

4. The control knob of claim 3, wherein the wireless communication interface comprises:
an ultra-wideband antenna, and
an ultra-wideband transceiver electrically connected to the ultra-wideband antenna.

5. The control knob of claim 4, wherein the bottom portion further comprises a wireless charging coil installed on the inner surface of the contact panel.

6. A vehicle comprising:
a display device comprising a magnetic material portion, wherein the magnetic material portion is configured to attach, by magnetic force, to a magnet installed in a removable control knob; and
a controller circuit configured to:
transmit, to the removable control knob and based on a user input signal indicating an operation mode of the removable control knob, a corresponding control knob mode switching signal;
based on the operation mode of the removable control knob being a multi-function mode and based on receiving the user input signal regarding a control function, transmit, to the removable control knob that is attached to the display device, control function information corresponding to the user input signal; and
control, based on an operation signal for the control function received from the removable control knob that is attached to the display device, the control function.

7. The vehicle of claim 6, wherein the controller circuit is configured to transmit the control function information by:
detecting whether the removable control knob is attached to the display device when the user input signal is received; and
based on detecting that the removable control knob is attached to the display device when the user input signal is received, transmitting the control function information that corresponds to the user input signal.

8. The vehicle of claim 6, wherein the control circuit is further configured to:
detect whether the removable control knob is attached to the display device when a second user input signal is received; and
based on detecting that the removable control knob is not attached to the display device when the second user input signal is received, not respond to the second user input signal.

9. The vehicle of claim 6, wherein the controller circuit is further configured to:
detect a position, relative to the display device, of the removable control knob attached to the display device; and
adjust, based on the detected position of the removable control knob attached to the display device, a layout of a user interface of the display device so that the removable control knob does not obscure information on the user interface.

10. The vehicle of claim 6, wherein the control function information comprises a control function type, and
wherein the control function type comprises at least one of: a seat control function, a multimedia playback control function, or an air conditioning control function.

11. A method performed by an apparatus for a vehicle, the method comprising:
receiving a user input requesting to switch an operation mode of a removable control knob of the vehicle to a multi-function mode;
switching, based on the receiving of the user input requesting to switch to the multi-function mode, the operation mode of the removable control knob to the multi-function mode by transmitting, to the removable control knob, a control knob mode switching signal for the multi-function mode;
receiving a user input signal regarding a control function;
based on receiving the user input signal, transmitting, to the removable control knob that is attached to a display device of the vehicle, control function information to cause the removable control knob to display, on a touch display panel of the removable control knob, a control knob user interface corresponding to the control function information;
receiving, from the removable control knob, an operation signal, for the control function, corresponding to a user operation of the removable control knob; and
controlling, based on the operation signal, the control function.

12. The method of claim 11, further comprising:
receiving a second user input requesting to switch the operation mode of the removable control knob to a remote-control mode; and
transmitting, to the removable control knob and based on the receiving of the second user input, a second control knob mode switching signal for the remote-control mode.

13. The method of claim 11, further comprising:
receiving a second user input requesting to switch the operation mode of the removable control knob to a smart key mode; and
transmitting, to the removable control knob and based on the receiving of the second user input, a second control knob mode switching signal for the smart key mode.

14. The method of claim 11, wherein the transmitting of the control function information comprises:
detecting whether the removable control knob is attached to the display device when the user input signal is received; and
based on detecting the removable control knob is attached to the display device when the user input signal is received, transmitting the control function information that corresponds to the user input signal.

15. The method of claim 11, further comprising:
detecting whether the removable control knob is attached to the display device when a second user input signal is received; and
based on detecting that the removable control knob is not attached to the display device when the second user input signal is received, not responding to the second user input signal.

16. The method of claim 11, further comprising:
detecting a position, relative to the display device, of the removable control knob attached to the display device; and
adjusting, based on the detected position of the removable control knob attached to the display device, a layout of a vehicle user interface of the display device so that the removable control knob does not obscure information on the vehicle user interface.

17. The method of claim 11, wherein the removable control knob comprises an bottom portion,
wherein a contact panel is provided on a bottom surface of the bottom portion,
wherein a magnet is installed on an inner surface of the contact panel,
wherein a magnetic material portion is installed inside the display device of the vehicle, and
wherein the magnet is attached to the magnetic material portion by magnetic force so that the removable control knob is attachable to the display device of the vehicle.

18. The method of claim 11, wherein the removable control knob comprises a top portion and a bottom portion,
wherein the top portion is configured to:
connect to the bottom portion;
rotate with respect to the bottom portion; and
be pressed with respect to the bottom portion,
wherein the top portion comprises the touch display panel being provided on an upper surface of the top portion, and
wherein the user operation comprises at least one of: a rotation of the top portion, a press of the top portion, or a touch input on the touch display panel.

19. The method of claim 11, further comprising:
detecting a position of the removable control knob via ultra-wideband communication with the removable control knob to determine whether the removable control knob is attached to the display device and determine an attachment position of the removable control knob relative to the display device.

20. The method of claim 11, wherein the control function information comprises a control function type, and wherein the control function type comprises at least one of: a seat control function, a multimedia playback control function, or an air conditioning control function.
